(19) United States
(12) Patent Application Publication
(10) Pub. No.: US 2011/0095974 A1
(43) Pub. Date: Apr. 28, 2011

(54) DISPLAY DEVICE AND METHOD OF CONTROLLING DISPLAY DEVICE

(75) Inventor: Toshiki Moriwaki, Kanagawa (JP)

(73) Assignee: SONY CORPORATION, Tokyo (JP)

(21) Appl. No.: 12/907,090

(22) Filed: Oct. 19, 2010

(30) Foreign Application Priority Data
Oct. 28, 2009 (JP) 2009-247517

(51) Int. Cl. G06F 3/01

(52) U.S. Cl. 345/156

(57) ABSTRACT

A display device includes a flexible substrate, a display unit including a plurality of light-emitting elements arranged at the substrate and configured to display an image according to an image signal, a displacement sensor provided to a front surface or a back surface of the substrate and configured to detect a curved state of the substrate, and a pixel shift control unit configured to control pixel shifting of the image displayed in the display unit when a curve of the substrate is detected by the displacement sensor.

### BACKGROUND OF THE INVENTION

1. Field of the Invention

The present invention relates to a display device and a method of controlling a display device.

2. Description of the Related Art

In recent years, ensuring reliability of a display element in a display device has become an extremely important challenge. Particularly, ensuring structural and mechanical reliability or reliability relating to display performance is still a crucial matter as has been in the past.

For example, Japanese Unexamined Patent Application Publication No. 2005-173193 discloses a technique in which a situation of an image is determined from data, such as image data, that can indicate a display state of a device and lighting of a horizontal scan line is controlled to prevent overcurrent, in order to prevent life degradation of an element due to temperature rise according to current flow amount.

Also, Japanese Unexamined Patent Application Publication No. 2007-240617 describes that control of an optical characteristic such as refractive index is performed using a photodetector as a polarization detecting unit by quantitatively detecting a change amount of deformation due to minute stress applied to a display device as a change in polarization state of incident light.

### SUMMARY OF THE INVENTION

However, the technique described in Japanese Unexamined Patent Application Publication No. 2005-173193 has a problem in that manufacturing cost increases in order to ensure reliability, since various feedback controls are used, i.e., many algorithms are used, for complex control combining both a gate signal and a source signal, control of lighting period, and the like. Also, a complex algorithm control leads to an increase in power consumption of a driver IC, causing a decrease in power performance.

With the technique described in Japanese Unexamined Patent Application Publication No. 2007-240617, detecting a minute change in refractive index according to deformation is difficult when there is noise due to reflection of external light or light scattering by relatively strong external light from another light source such as sunlight or fluorescent light in a room.

Thus, it is desirable to provide a novel and improved display device and method of controlling a display device that enable reliable prevention of degradation in display performance of a flexible display device.

According to an embodiment of the present invention, there is provided a display device including a flexible substrate, a display unit including a plurality of multiple light-emitting elements arranged at the substrate and configured to display an image according to an image signal, a displacement sensor provided to a front surface or a back surface of the substrate and configured to detect a curved state of the substrate, and a pixel shift control unit configured to control pixel shifting of the image displayed in the display unit when a curve of the substrate is detected by the displacement sensor.

The pixel shift control unit may execute the pixel shifting in a curved portion when the curve of the substrate is detected by the displacement sensor.

The pixel shift control unit may control the pixel shifting according to a curve amount of the substrate.

The pixel shift control unit may recover a movement amount of the image in the pixel shifting to zero when a recovery of the curved substrate to a flat surface state is detected.

The display device may further include a pixel shift amount calculation unit configured to calculate a pixel shift amount based on a lookup table specifying a relation between an output of the displacement sensor and the pixel shift amount. The pixel shift control unit may control the pixel shifting based on the pixel shift amount.

The pixel shift amount calculation unit may determine the pixel shift amount to be zero when an output value of the displacement sensor is less than or equal to a predetermined threshold value.

The pixel shift amount calculation unit may calculate the pixel shift amount based on the lookup table which differs for a case where the substrate is curved and for a case where the curved substrate recovers to a flat surface.

It may be such that the displacement sensor includes a pair of transparent electrodes formed of ITO or IZO and is configured to detect the curved state of the substrate based on a change in resistance value between the pair of transparent electrodes.

According to another embodiment of the present invention, there is provided a method of controlling a display device, including the steps of detecting a curved state of a flexible substrate provided with a display unit configured to display an image according to an image signal, and controlling pixel shifting of the image displayed in the display unit when a curve of the substrate is detected.

The pixel shifting may be executed in a curved portion in the step of controlling the pixel shifting when the curve of the substrate is detected.

The pixel shifting may be controlled according to a curve amount of the substrate in the step of controlling the pixel shifting.

The method of controlling a display device may further include a step of recovering a shift amount of the image in the pixel shifting to zero when a recovery of the curved substrate to a flat surface state is detected.

The method of controlling a display device may further include a step of calculating a pixel shift amount based on a lookup table specifying a relation between a value corresponding to a curve amount of the substrate and the pixel shift amount. The pixel shifting may be controlled based on the pixel shift amount in the step of controlling the pixel shifting.

The pixel shift amount may be calculated based on the lookup table which differs for a case where the substrate is curved and for a case where the curved substrate recovers to a flat surface in the step of calculating the pixel shift amount.

It may be such that the curved state of the substrate is detected based on an output value of a displacement sensor provided to a front surface or a back surface of the substrate in the step of detecting the curved state of the substrate, and the pixel shifting is not performed when the output value of the displacement sensor is less than or equal to a predetermined threshold value.

According to the embodiments of the present invention, it is possible to reliably prevent degradation in display performance of a flexible display device.

### BRIEF DESCRIPTION OF THE DRAWINGS

FIG. 1 is a plan view showing a surface on the front side of a display device according to an embodiment of the present invention;

FIG. 2 is a schematic view showing a sectional surface of the display device;

FIG. 3 illustrates an example in which a displacement sensor is provided to the back surface side of a display unit, and is a plan view showing a back surface of the display device;

FIG. 4 illustrates the example in which the displacement sensor is provided to the back surface side of the display unit, and is a schematic view showing a sectional surface of the display device;

FIG. 5 illustrates a state where the display device is curved, and is a schematic view showing a curved state where the surface on the front side provided with the display unit is a concave surface;

FIG. 6 is a schematic view showing a curved state where the surface provided with the display unit is a convex surface;

FIG. 7 is a block diagram showing the functional configuration of the display device according to this embodiment;

FIG. 8 is a schematic view showing an example of an LUT specifying a pixel shift amount according to a resistance change amount;

FIG. 9 is a schematic view showing another example of the LUT specifying the pixel shift amount;

FIG. 10 is a schematic view showing the concept of pixel shifting;

FIG. 11 illustrates a sectional surface of the display device, and is a schematic view showing a configuration example in which the displacement sensor is provided to front and back surfaces of the display device;

FIG. 12 is a schematic view showing a state where the display device shown in FIG. 11 is curved; and

FIG. 13 is a schematic view showing another example of the lookup table.

### DESCRIPTION OF THE PREFERRED EMBODIMENTS

A preferred embodiment of the present invention will be described in detail below with reference to the accompanying drawings. Note that, in this specification and the drawings, components having substantially the same functional configuration are denoted by the same reference numeral to omit redundant description.

Note that descriptions will be given in the following order.

1. Configuration example of display device
2. Function block configuration of display device
3. Calculation of pixel shift amount
4. Configuration example in which displacement sensors are provided to front and back surfaces
5. Another example of lookup table

### [1. Configuration Example of Display Device]

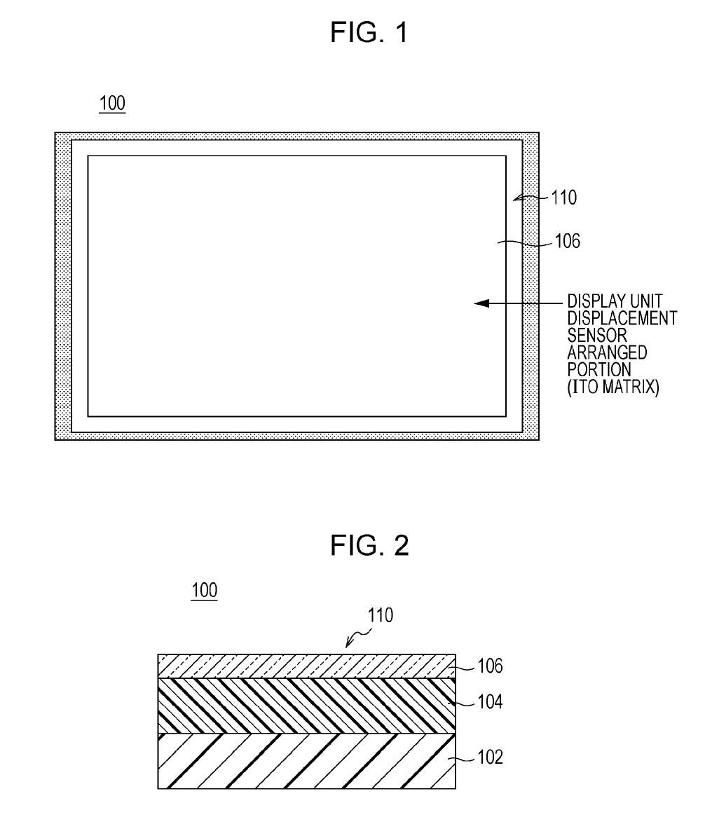

First, with reference to FIGS. 1 and 2, a schematic configuration of a display device 100 according to an embodiment of the present invention will be described. FIG. 1 is a plan view showing a surface on the front side of the display device 100. The display device 100 includes a display unit 110 including a semiconductor layer described later and in which a plurality of pixels are arranged in a matrix. The display unit 110 displays an image such as a still image or a moving image by causing each pixel to emit light according to an image signal.

In this embodiment, a flexible characteristic allows for a free curving movement. At the same time, screen burn-in due to fixed display is prevented to ensure reliability of display by performing, in response to a curving and to suit a bend-degree amount, pixel shifting for a fixed display image in the display device according to a detected displacement amount in a fixed display portion.

FIG. 2 is a schematic view showing a sectional surface of the display device 100. In this embodiment, as shown in FIG. 2, a first substrate 102, a second substrate 104, and a displacement sensor 106 are stacked to form the extremely thin display device 100 having a thickness of approximately several tens of micrometers. The first substrate 102 is configured with a display element (light-emitting element), which is included in each pixel, formed on a flexible substrate, e.g., a plastic substrate formed of resin. As the display element, an organic semiconductor or inorganic semiconductor element that can be formed by a low-temperature process may be used. In this embodiment, an organic electroluminescence (EL) element is formed as the display element in the first substrate 102.

The second substrate 104 is also formed of a plastic substrate formed of resin, is arranged to face the first substrate 102 including the display element formed of an organic semiconductor or an inorganic semiconductor, and has a function as a sealing substrate that seals in the display element. In this manner, the display device 100 is formed by two types of substrates, i.e., the first substrate 102 and the second substrate 104, holding the semiconductor layer in between in this embodiment. The display unit 110 displays an image on a surface on the second substrate 104 side. With such a configuration, the display device 100 is formed with a thickness of approximately several tens of micrometers, has flexibility, and can be curved freely in a state where an image is displayed.

As shown in FIGS. 1 and 2, the displacement sensor 106 formed of a transparent electrode body, e.g., an ITO film or IZO film, is arranged on a surface of the second substrate 104. The displacement sensor 106 is formed, for example, in a same region as the display unit 110. The displacement sensor 106 is formed of the transparent electrode body, and is each arranged to face the display element of the first substrate 102.

The displacement sensor 106 has a configuration similar to, for example, an electrode for an available touchscreen. Two metal thin films (resistance films) formed of a transparent electrode of ITO, IZO, or the like are arranged to face each other, and a plurality of pairs of the metal thin films are arranged, for example, in a matrix in a flat surface region. The facing transparent electrodes of the displacement sensor 106 have resistance. One of the electrodes is applied with predetermined voltage, and a resistance value between the electrodes is monitored. With such a configuration, a change in the resistance value can be detected because, when the display device 100 is curved, the resistance value between the two metal thin films changes at a position of a curve and voltage according to the curve is generated at the other electrode. Thus, by detecting the metal thin films for which the resistance value has changed out of the plurality of pairs of the metal thin films arranged in the matrix, a position of displacement among the displacement sensors 106 can be detected and a position of bend in the display unit 110 can be detected. The change in the resistance value increases as a bend amount of the display device 100 increases. In this manner, the display device 100 can detect a resistance change amount detected by the displacement sensor 106 and detect a bend position and the bend amount of the display device 100.

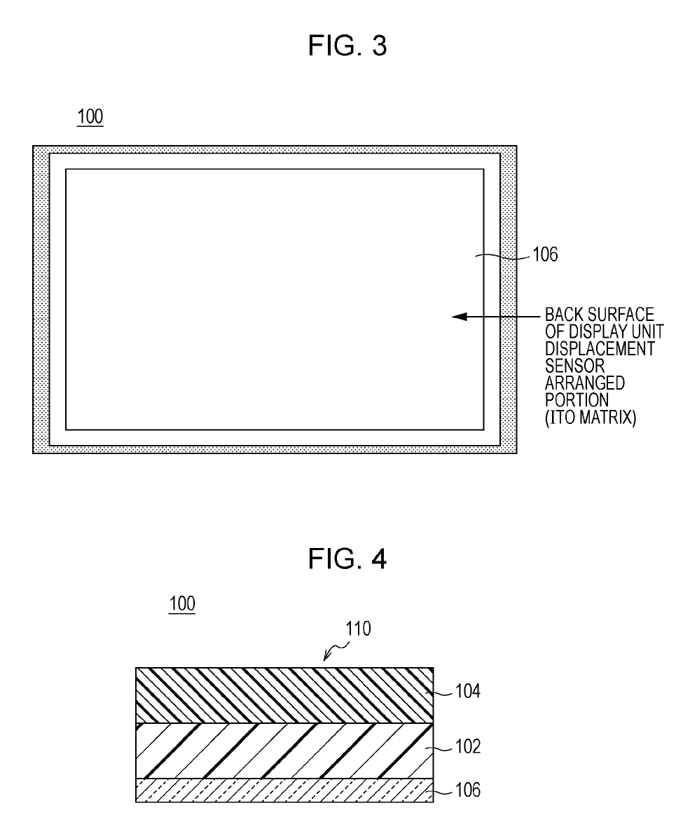

FIGS. 3 and 4 are schematic views showing an example in which the displacement sensor 106 is provided to the back surface side of the display unit 110. Herein, FIG. 3 shows a plan view of a back surface of the display device 100, and FIG. 4 shows a sectional view of the display device 100. In FIGS. 3 and 4, the configuration of the first substrate 102 and the second substrate 104 is similar to that in the display device 100 in FIGS. 1 and 2. In this configuration example, as shown in FIG. 4, the displacement sensor 106 is provided to a back surface of the first substrate 102. A curve amount and a curve position of the display device 100 can be detected according to a change in the resistance value also when the displacement sensor 106 is provided to the back surface of the display unit 110, in a similar manner to when the displacement sensor 106 is provided to a front surface of the display unit 110.

It is common for a so-called screen burn-in phenomenon to occur when a fixed image is displayed for a long period of time with a display device using a self-luminous, e.g., organic EL, display element. The screen burn-in phenomenon occurs in, for example, a display region where there is luminance difference in an image, due to a difference in degree of degradation of a light-emitting material according to usage. In an actual display, accumulated light-emitting times of the light-emitting material corresponding to respective display cells are not uniform but vary according to an image that has been displayed thus far. Accordingly, degrees of degradation of the light-emitting material vary among the display cells, causing the screen burn-in phenomenon to occur. When there is luminance difference in an image, it is common for the screen burn-in phenomenon to occur relatively easily with a fixed image display in which the image is displayed continuously.

In this embodiment, in view of the screen burn-in phenomenon, pixel shifting is performed in a predetermined amount for a display pixel of the display unit 110 based on a displacement amount (bend amount) of the display unit 110 at a time of curving obtained from the resistance change amount by causing an output control with respect to the display element formed of the organic semiconductor or inorganic semiconductor included in the first substrate 102 to correspond with a detected value of the resistance change amount in the resistance value detected by the displacement sensor 106. Accordingly, in this embodiment, the reliability of the display unit 110 is ensured by controlling the screen burn-in phenomenon in the display unit 110 caused by an unchanging display.

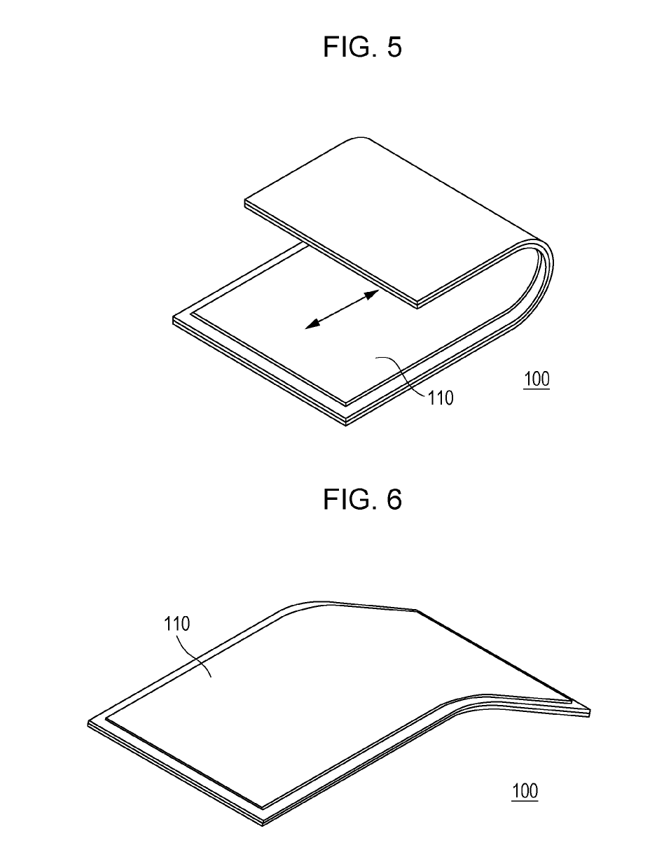

FIG. 5 is a schematic view showing a state where the display device 100 is curved, and illustrates a curved state where the surface on the front side provided with the display unit 110 is a concave surface. FIG. 6 illustrates a curved state where the surface provided with the display unit 110 is a convex surface.

In the state where the display device 100 is curved, as shown in FIGS. 5 and 6, it is less important to maintain a normal display state of an image since the visibility of the display unit 110 is reduced by the curve. For example, as in FIG. 5, the image on a display screen is also curved when the curve is such that the display screen is the concave surface. Also, due to the influence of light scattering or the like on the surface, the image quality also decreases compared to when the surface is a flat surface. Therefore, even when the pixel shifting is performed, the user can be prevented from feeling a sense of strangeness. Particularly, when the display screen of the display unit 110 is bent at an angle of approximately 180° as in FIG. 5, the pixel shifting is not viewed by the user since a region is formed in which the image in the display unit 110 is rarely visible from outside. In a similar manner, when the curve is such that the display screen of the display unit 110 is the convex surface as in FIG. 6, the user can be prevented from feeling a sense of strangeness even when the pixel shifting is performed since the image on the display screen is also curved and the image quality decreases. In this manner, when the display unit 110 is curved, the pixel shifting is performed in consideration of the less importance of maintaining the fixed image display in this embodiment. Accordingly, it is possible to ensure reliability of display quality of the display device 100 without giving the user a sense of strangeness.

The pixel shifting is performed in a region corresponding to a curved portion in which a resistance change is detected among the plurality of displacement sensors 106 arranged in the matrix. Accordingly, in a region without a curve, the visibility of the image can be maintained at a high level since the pixel shifting is not performed. As a curve amount of the display unit 110 increases, the influence of the pixel shifting is viewed less since a curve amount of the image on the display screen increases. Therefore, in this embodiment, the pixel shifting is performed in conjunction with the bend-degree amount, only for a certain corresponding number of pixels relative to the bend amount of the display device 100. When the display unit 110 has recovered from the curved state to a flat surface, a pixel shift amount is accordingly recovered to an original state of zero. Note that, with a normal display device that does not curve, pixel shift control for preventing screen burn-in is viewed by the user, giving the user a sense of strangeness. However, in this embodiment, the user can rarely recognize the pixel shifting and the user does not feel a sense of strangeness even when pixel shift control is performed since the pixel shift control for preventing screen burn-in is performed in the curved state. Thus, it is possible to ensure reliability of the display device without having the user recognize the pixel shift control.

### [2. Function Block Configuration of Display Device]

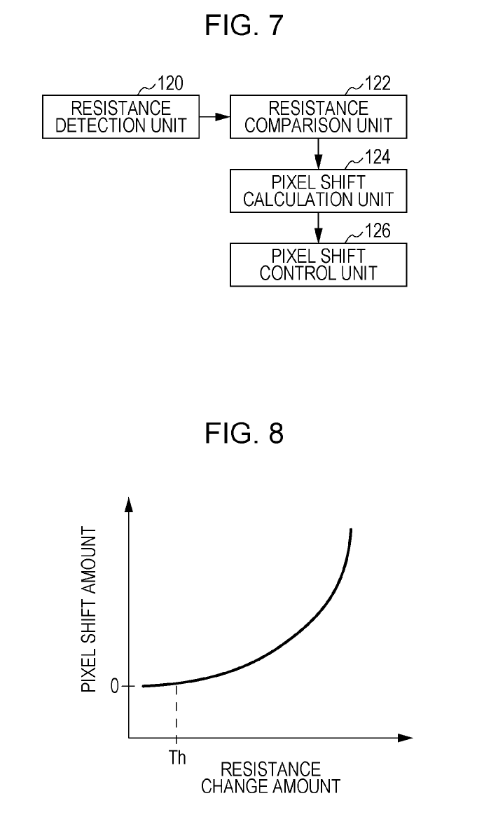

A specific control technique will be described below. FIG. 7 is a block diagram showing the functional configuration of the display device 100 according to this embodiment. A function block shown in FIG. 7 may include hardware, such as a sensor or a circuit, or a central processing unit (CPU) with software (program) for enabling a function thereof. As shown in FIG. 7, the display device 100 includes a resistance detection unit 120, a resistance comparison unit 122, a pixel shift calculation unit 124, and a pixel shift control unit 126. The resistance detection unit 120 corresponds to the displacement sensor 106 described above, and the resistance detection unit 120 detects the resistance value as an analog value corresponding to the curve amount. With the resistance value detected by the resistance detection unit 120, the change amount is detected by the resistance comparison unit 122. The resistance comparison unit 122 detects the change amount by comparing a reference resistance value in a flat surface state where the display device 100 is not curved and the resistance value detected by the resistance detection unit 120.

When the resistance change amount is detected, the resistance comparison unit 122 outputs the change amount to the pixel shift calculation unit 124. Also, when the resistance change amount is detected, the resistance comparison unit 122 inputs position information of the pertinent displacement sensor 106 to the pixel shift control unit 126. When the resistance change amount is not detected, i.e., when the resistance value detected by the resistance detection unit 120 and the reference resistance value do not differ, the resistance change amount is not output to the pixel shift calculation unit 124 since the display device 100 is not curved. The pixel shift calculation unit 124 determines the pixel shift amount of the display unit 110 according to the input change amount. The pixel shift amount determined in the pixel shift calculation unit 124 is output to the pixel shift control unit 126, and the pixel shifting in the display unit 110 is controlled by the pixel shift control unit 126. The pixel shift control unit 126 performs the pixel shifting in the region corresponding to the curved portion in which the resistance change is detected among the plurality of displacement sensors 106 arranged in the matrix. Therefore, the pixel shift control unit 126 performs the pixel shifting in the region corresponding to the curved portion based on the position information, which is input from the resistance comparison unit 122, of the displacement sensor 106 where the resistance change has occurred.

### [3. Calculation of Pixel Shift Amount]

In the pixel shift calculation unit 124, the pixel shift amount to be controlled according to the resistance change amount is stored in advance in the form of a lookup table (LUT). FIG. 8 is a schematic view showing an example of the LUT specifying the pixel shift amount according to the resistance change amount. In this manner, the pixel shift control is performed using linear data stored in advance in this embodiment. As shown in FIG. 8, a value of the pixel shift amount is set to be small when the resistance change amount is small. The pixel shift amount is set, for example, to increase exponentially as the resistance change amount increases. Accordingly, the display performance can be maintained at a high level by applying a small pixel shift amount when a bend of the display unit 110 is small. Since the pixel shifting is recognized relatively easily when the curve amount of the display unit 110 is small, the pixel shifting is prevented from being recognized by the user by applying the small pixel shift amount.

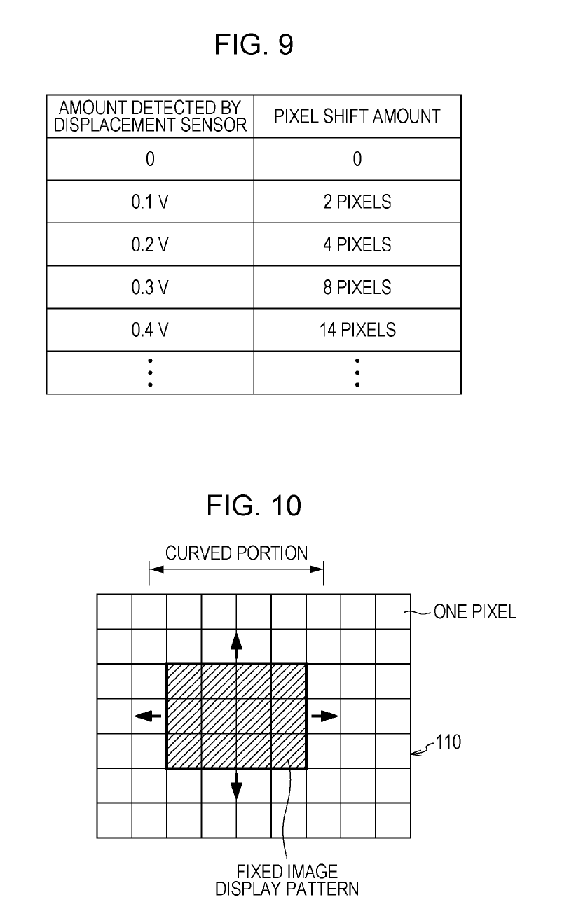

FIG. 9 is a schematic view showing another example of the LUT specifying the pixel shift amount. In the example shown in FIG. 9, a relation between a voltage value (value corresponding to the resistance value) detected by the displacement sensor 106 and the pixel shift amount is specified. When a predetermined voltage is applied to one of the transparent electrodes of the displacement sensor 106, the voltage value with respect to a reference voltage of the other electrode of the displacement sensor 106 increases as the curve amount increases, the reference voltage being a voltage value of the other electrode in the state where the display device 100 is not curved. Thus, the pixel shift amount can be obtained by looking up the voltage value with respect to the reference voltage of the other electrode of the displacement sensor 106 in the LUT in FIG. 9.

For example, assume that, at an arbitrary point (position) among the displacement sensors 106, the resistance comparison unit 122 detects a difference of 0.2 V between a detected voltage value of the transparent electrode of the displacement sensor 106 and the reference voltage for when the curve is not present. In this case, the pixel shift calculation unit 124 calculates the pixel shift amount according to a detected difference amount, and determines the pixel shift amount as 4 pixels in the example in FIG. 9. Then, the pixel shift control unit 126 executes the pixel shifting vertically and horizontally for a certain period. When there is luminance difference in an image, occurrence of the screen burn-in can be prevented by performing the pixel shifting since a continuous display of the image is avoided. In this manner, the screen burn-in can be prevented by performing the pixel shifting according to a difference in the resistance value created according to the curve of the display device 100 in this embodiment.

As shown in FIG. 8, the lookup table specifies that the pixel shift amount is zero in a predetermined range in which the resistance change amount is small and that the pixel shifting is to be performed when the resistance change amount exceeds a predetermined threshold value Th. In this manner, by setting a deadband before the pixel shifting is actually performed, the pixel shifting can be not performed when the display device 100 is curved minutely. Accordingly, since the pixel shifting is not performed with a minute deformation of the display device 100, the user can be prevented from feeling a sense of strangeness.

FIG. 10 is a schematic view showing the concept of the pixel shifting, and shows how the pixel shifting is performed in the curved portion of the display device 100. As shown in FIG. 10, when the curve of the display unit 110 is detected from a change in the resistance value, a fixed image display pattern displayed in the curved portion is moved vertically and horizontally (in directions of arrows in FIG. 10) by a predetermined number of pixels within a predetermined period of time. Alternatively, the pixel shifting may be performed in cycles such that a fixed display pattern rotates clockwise (or counterclockwise) within a range of predetermined pixels. Control of the pixel shifting by the pixel shift control unit 126 is not particularly limited, and may be performed with a common and general technique. For example, the pixel shifting may be performed by varying the display timing of an image by a predetermined number of clock cycles to vary the timing of data readout in units of pixel. More specifically, when the control to move the fixed image display pattern displayed in the curved portion vertically and horizontally (in the directions of the arrows in FIG. 10) by the predetermined number of pixels within the predetermined period of time is such that the pixel shift control in conjunction with the resistance change amount created by the curve is performed in cycles, control is performed to shorten the cycle correspondingly as the pixel shift amount increases. That is, by causing the cycle of the pixel shifting to correspond to the increased pixel shifting such that the cycle of the pixel shifting is shortened, the pixel shift control of a fixed display is performed increasingly according to the curve to thereby control the screen burn-in due to the fixed display.

As a result, in a display region that is not viewed from the user side at the time of curving due to the visibility of the display unit 110 being decreased by the curve, the screen burn-in is prevented to ensure the reliability of display by cancelling the fixed image display and controlling the pixel shifting of the image displayed in the display unit 110 according to the curve amount.

Note that the image in the fixed image display by which the screen burn-in in the display unit 110 occurs relatively easily is not particularly limited, and may be, for example, that for which an image signal level stays constant within a certain frame frequency. Further, a state (rate) of a constant signal level for determining a fixed image display may be set arbitrarily on the user side through an input or the like with respect to the display device 100.

As described above, in the display device 100 of this embodiment, the curve amount is detected by the displacement sensor 106 and the pixel shifting is controlled in conjunction with the curve amount to prevent degradation by screen burn-in caused by image display. Accordingly, in the display region which is hardly visible from the user side at the time of curving, the reliability of display can be ensured by cancelling the image display and controlling the pixel shifting of the display unit 110 according to the curve amount.

[4. Configuration Example in which Displacement Sensor is Provided to Front and Back Surfaces]

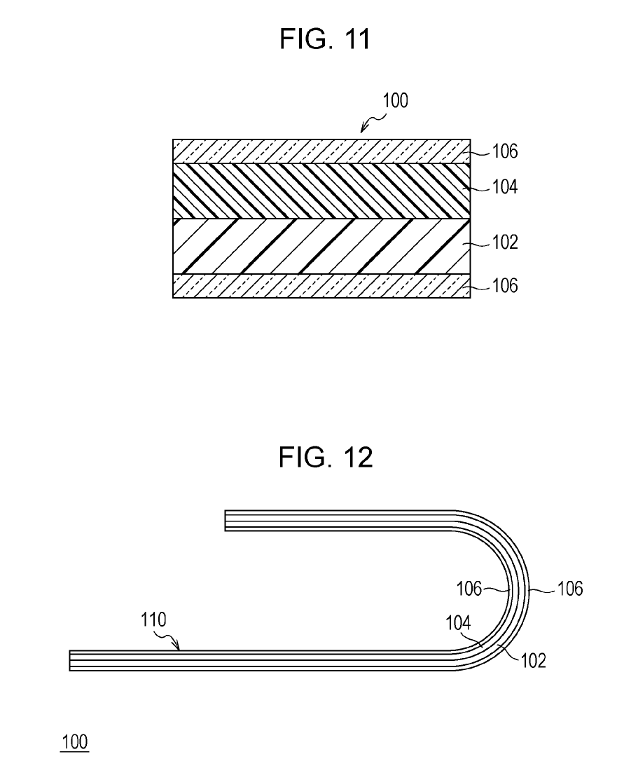

FIG. 11 is a schematic view showing a sectional surface of the display device 100, and shows a configuration example in which the displacement sensor is provided to front and back surfaces of the display device 100. FIG. 12 is a schematic view showing a state where the display device 100 shown in FIG. 11 is curved. In the curved portion in the case of FIG. 12, a radius of curvature of the displacement sensor 106 on the back surface side where the display unit 110 is not provided is greater than a radius of curvature of the displacement sensor 106 on the front surface side where the display unit 110 is provided. More specifically, the radius of curvature of the displacement sensor 106 on the back surface side is greater by the thickness of the first substrate 102 and the second substrate 104. Therefore, a curve amount of the displacement sensor 106 on the front surface side is greater compared to a curve amount of the displacement sensor 106 on the back surface, and the resistance change amount of the displacement sensor 106 on the front surface side where the curve amount is greater is greater than the resistance change amount of the displacement sensor 106 on the back surface side.

Thus, when the resistance change amounts are detected by the displacement sensors 106 on the front and back surfaces in the configuration shown in FIG. 11, comparing the resistance change amounts of the front and back surfaces allows one of the front and back surfaces to be detected as a concave surface and the other as a convex surface. When the front surface is the concave surface, it is possible to control the pixel shift amount to increase, since the pixel shifting is less conspicuous due the display unit 110 being more hidden from the outside compared to when the front surface is the convex surface and the display unit 110 being less recognizable. On the other hand, when the front surface is the convex surface, it is possible to prevent the user from feeling a sense of strangeness from the pixel shifting by reducing the pixel shift amount compared to when the front surface is the concave surface, since the image itself is recognizable despite the image being curved.

Although the directions of the pixel shifting are vertical and horizontal directions in the example described above, a curved direction of the display device 100 may be detected based on an output of the displacement sensor 106 to perform the pixel shifting in the curved direction. For example, in the example in FIG. 5, the pixel shifting may be performed along the curved direction (shown by an arrow in FIG. 5). Accordingly, the pixel shifting can be made less conspicuous, and the pixel shifting can be prevented reliably from being recognized by the user.

### [5. Another Example of Lookup Table]

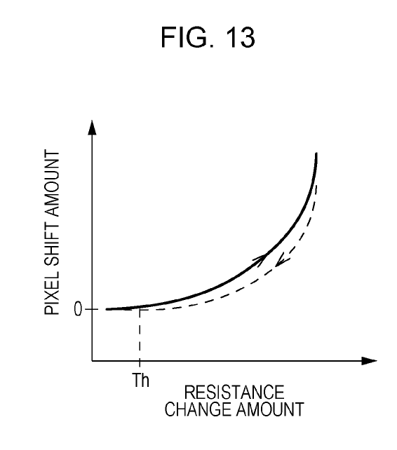

FIG. 13 is a schematic view showing another example of the lookup table. In the example shown in FIG. 13, the pixel shift amounts with respect to the resistance change amount are different in a process in which the display device 100 is bent and a process in which a bend is recovered.

In the lookup table shown in FIG. 13, a characteristic curve (shown by a solid line in FIG. 13) in the process in which the display device 100 is bent is similar to that in FIG. 8. On the other hand, a characteristic curve shown by a broken line in FIG. 13 is applied in the process in which the bend is recovered, so that a change amount of the pixel shift amount with respect to the resistance change amount is greater in a region in which the resistance change amount is great and the change amount of the pixel shift amount with respect to the resistance change amount is smaller in a region in which the resistance change amount is small. Accordingly, when a bent state recovers to a flat surface, an image applied with the pixel shifting can recover to an original state at a relatively early stage. Thus, the pixel shifting can be prevented reliably from giving the user a sense of strangeness when the curved display device 100 recovers to the flat surface.

The present application contains subject matter related to that disclosed in Japanese Priority Patent Application JP 2009-247517 filed in the Japan Patent Office on Oct. 28, 2009, the entire content of which is hereby incorporated by reference.

The preferred embodiment of the present invention has been described above in detail with reference to the accompanying drawings. However, the present invention is not limited to the examples. It is clear to those skilled in the art to which the present invention pertains that various modifications or alterations are conceivable within the scope of the technical idea described in the claims, and it should be understood that they are also naturally within the technical scope of the present invention.

What is claimed is:

1. A display device comprising:
a flexible substrate;
a display unit including a plurality of light-emitting elements arranged at the substrate and configured to display an image according to an image signal;
a displacement sensor provided to a front surface or a back surface of the substrate and configured to detect a curved state of the substrate; and
a pixel shift control unit configured to control pixel shifting of the image displayed in the display unit when a curve of the substrate is detected by the displacement sensor.

2. The display device according to claim 1, wherein the pixel shift control unit executes the pixel shifting in a curved portion when the curve of the substrate is detected by the displacement sensor.

3. The display device according to claim 1, wherein the pixel shift control unit controls the pixel shifting according to a curve amount of the substrate.

4. The display device according to claim 1, wherein the pixel shift control unit recovers a movement amount of the image in the pixel shifting to zero when a recovery of the curved substrate to a flat surface state is detected.

5. The display device according to claim 1, further comprising:
a pixel shift amount calculation unit configured to calculate a pixel shift amount based on a lookup table specifying a relation between an output of the displacement sensor and the pixel shift amount;
wherein the pixel shift control unit controls the pixel shifting based on the pixel shift amount.

6. The display device according to claim 5, wherein the pixel shift amount calculation unit determines the pixel shift amount to be zero when an output value of the displacement sensor is less than or equal to a predetermined threshold value.

7. The display device according to claim 5, wherein the pixel shift amount calculation unit calculates the pixel shift amount based on the lookup table which differs for a case where the substrate is curved and for a case where the curved substrate recovers to a flat surface.

8. The display device according to claim 1, wherein the displacement sensor includes a pair of transparent electrodes formed of ITO or IZO and is configured to detect the curved state of the substrate based on a change in resistance value between the pair of transparent electrodes.

9. A method of controlling a display device, comprising the steps of:
detecting a curved state of a flexible substrate provided with a display unit configured to display an image according to an image signal; and
controlling pixel shifting of the image displayed in the display unit when a curve of the substrate is detected.

10. The method of controlling a display device according to claim 9, wherein the pixel shifting is executed in a curved portion in the step of controlling the pixel shifting when the curve of the substrate is detected.

11. The method of controlling a display device according to claim 9, wherein the pixel shifting is controlled according to a curve amount of the substrate in the step of controlling the pixel shifting.

12. The method of controlling a display device according to claim 9, further comprising a step of recovering a shift amount of the image in the pixel shifting to zero when a recovery of the curved substrate to a flat surface state is detected.

13. The method of controlling a display device according to claim 9, further comprising a step of:
calculating a pixel shift amount based on a lookup table specifying a relation between a value corresponding to a curve amount of the substrate and the pixel shift amount;
wherein the pixel shifting is controlled based on the pixel shift amount in the step of controlling the pixel shifting.

14. The method of controlling a display device according to claim 13, wherein the pixel shift amount is calculated based on the lookup table which differs for a case where the substrate is curved and for a case where the curved substrate recovers to a flat surface in the step of calculating the pixel shift amount.

15. The method of controlling a display device according to claim 9, wherein the curved state of the substrate is detected based on an output value of a displacement sensor provided to a front surface or a back surface of the substrate in the step of detecting the curved state of the substrate, and the pixel shifting is not performed when the output value of the displacement sensor is less than or equal to a predetermined threshold value.
